(19) United States
(12) Patent Application Publication
(10) Pub. No.: US 2001/0049817 A1
(43) Pub. Date: Dec. 6, 2001

(54) System developing method, storage medium, information processing apparatus, information terminal apparatus, information processing system, and information processing method

(76) Inventor: Yugo Kashiwagi, Tokorozawa (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/867,615

(22) Filed: May 31, 2001

(30) Foreign Application Priority Data
May 31, 2000 (JP) 2000-166468

(51) Int. Cl. G06F 9/44

(52) U.S. Cl. 717/4

(57) ABSTRACT

Supposing an information processing system having a server which receives a request of service via a transmission line or a network and provides the service, the server receives from a client address information such as an instruction address in an address space of the client to thereby provide the client with service corresponding to the address information, instead of calling a program of the server from the client. By adopting this protocol, the communication processing between the server and the client is simple. Furthermore, the cost reduction of the data processing system for providing a client or an information terminal apparatus with service via the network or the like can also be implemented.

### BACKGROUND OF THE INVENTION

1. Field of the Invention

The present invention relates to a system developing method which is optimum for development of an embedded system using a high level language such as the C++ language, and a storage medium which stores a program for such a system developing method. Furthermore, the present invention relates to an information processing system and an information processing method which can reduce the processing burden on a client or information terminal apparatus receiving the provision of service via a network, and which can provide service with due regard to such a burden reduction.

2. Description of the Related Art

A high level function (such as exception processing) possessed by a high level language such as C++, Fortran 90, or Java, which is a development language of a computer (herein, electronic computers such as computer apparatuses are simply referred to as “computers”) needs a large resource (such as a stack or memory). In a development language of an embedded system or a portable information terminal apparatus having many restrictions in a mounted memory or the like, a subset language for the high level language such as C++ is used. For example, the subset language of C++ called EC++ has been proposed. When using such a subset language, a source program is described in a range of a subset which does not include an exception processing function or the like possessed by C++, and is compiled in a processing system of the subset language. As a result, the high level language specifications can be implemented with a resource efficiency which is approximately equal to that of the conventional C language.

However, in the subset language, the program standardization is difficult. In other words, it becomes difficult to transport a program, which is developed on a personal computer or a work station, into a microcomputer or the like of the embedded use. Furthermore, since the subset does not have a complete language function (such as input-output or exception processing) to be used only during program debugging, the debugging similar to the development language environment of the full set cannot be conducted. The present inventor has revealed that this results in a worsened debug efficiency.

Therefore, in order to make the high level language functions of full set including the high level language function which can become an overhead for a target apparatus (such as a microcomputer or the like of embedded application) available to the system development, the present inventor has studied to reduce the load for the target apparatus. Especially, the present inventor has previously grasped that the load reduction being studied differs in basic viewpoint from a technique which distributes the processing among processors having uniform or equal processing capability as in a multi-processor compiler. The contents of the study conducted by the present inventor is to attempt to reduce the load in the high level language function unit.

Furthermore, the load reduction studied by the present inventor starts from putting the development environment in good condition, i.e., solving the problem that the debug efficiency also becomes poor because a development language of a subset does not have a complete high level language function (for example, such as output processing or exception processing) desired to be used even only during the program debugging. In this sense, the present inventor has studied to make a debugger bear the processing to be reduced, in the load reduction of the target apparatus. In particular, attention is paid to the fact that the debugger can easily implement the processing of the target apparatus to be reduced by utilizing the debug information generated in the course of compiling.

The present inventor has studied to expand the relation between the target apparatus and the debugger system not only to the development environment of the target system but also to the real system. Especially, in an information processing system having a host (server) and a terminal apparatus (client, target apparatus), the case where there is a great restriction on resources of the terminal apparatus is conceivable. Especially, in the case where the terminal apparatus is a portable information terminal apparatus such as PDA (Personal Digital Assistants) or a portable telephone, that trend is already noticeable. The present inventor has studied also a business model according to an information processing system or an information processing method which can provide service with due regard to the load reduction of the terminal apparatus in such an information processing system.

### SUMMARY OF THE INVENTION

An object of the present invention is to provide a system developing method which makes a full set of high level language function including a high level language function which can become an overhead for a target apparatus, available.

Another object of the present invention is to provide a system developing method which is optimum for developing an embedded system using a high level language such as the C++ language.

Still other object of the present invention is to provide a storage medium for storing a program which is capable of facilitating the system development using the above described system developing method.

A further object of the present invention is to provide an information processing apparatus, an information terminal apparatus, and an information processing system which implement the processing burden reduction of an information terminal apparatus receiving service via a network or the like.

A further object of the present invention is to implement the cost reduction of a data processing system which provides a client or an information terminal apparatus with service via a network or the like, and the simplification of the communication with a client.

The above described and other objects and novel features of the present invention will be made clear by the ensuing description and accompanying drawing.

Outlines of representative aspects of the present invention will be now described briefly.

(1) First, a basic concept will now be described by referring to an example. A high function corresponding portion (for example, such as the exception processing of C++) of the high level language which cannot be supported by the target apparatus of the development subject because of a resource or the like or which is not desired to be supported by the target apparatus becomes the subject of reduction. As to the high function corresponding portion in the source program, it is converted to the first code for implementing the function in a debugger system (or host apparatus), and in addition it is converted to the second code for the target for generating a request to make the debugger system (or host apparatus) conduct processing on the first code. The above described conversion is conducted utilizing a compiler or the like, for example. Furthermore, as a monitor function which makes a memory and a register of the target apparatus accessible, a monitor command sequence (client access command sequence) for the debugger system (or host) is generated. In the same way as the first command, the monitor command sequence is a code having a property which is activated in response to the execution of the second code.

When making the target apparatus execute the above described converted or compiled object program using the debugger to authenticate the source program, the target apparatus executes the second code in the high function corresponding portion of the high level language. The second code is a code of an interrupt instruction such as a TRAP instruction. There is no overhead when the high function corresponding portion of the high level language is supposed to have been executed. If the second code is the TRAP instruction, an interrupt handler determined by a vector peculiar to its instruction code or branch destination address is executed, and the target apparatus conducts communication with the debugger and gives an address (PC address) of the TRAP instruction to the debugger. The debugger takes in information of a stack area or the like on the target corresponding to the address of the given TRAP instruction, and executes the first code corresponding to the address of the given TRAP instruction using the information of the taken-in stack area or the like. In this way, the host apparatus executes or simulates the high function corresponding portion for the target apparatus. As a result, the load of the target apparatus can be reduced, while paying attention to the function unit of the high level language. Taking in information concerning the stack area or the like conducted by the debugger is conducted by executing the monitor command sequence. The access function using the monitor command sequence may be implemented via the function of the interrupt handler.

In the case where the high function corresponding portion of the high level language is a language function such as exception processing desired to be used exclusively only during the program debugging, the second code such as the TRAP instruction in the final object program may be replaced by a NOP (non-operation) instruction, after completion of the debugging. In this case, the target apparatus is operable while being disconnected from the host as a stand-alone system.

In the case where it is necessary to leave the second code in the final program (for example, such as the case where the load of the client is supposed to be reduced on the network in the real system), it becomes possible to leave the second code such as the TRAP instruction in the final program, to embed the first code, the monitor command sequence and so on in the host apparatus, and to make the host apparatus of the network execute the overhead portion which is the high function portion of the high level language, even after the operation of the final system.

(2) System developing method

First, the present invention will now be described from the viewpoint of the system developing method.

The system developing method has the following features:

(a) A first description in a source program (4) described by one development language and having a plurality of descriptions is converted to a first code which can be executed by a first computer (1);

(b) The first description is converted to a second code (TRAP instruction code) which represents a function different from a function defined by the first description, and which can be executed by a second computer (3). Furthermore, a second description in the source program is converted to a third code which can be executed by the second computer; and

(c) In the debugging of the source program, the first computer executes the first code in response to the execution of the second code by the second computer.

Thereby, in a unit of the high function portion of the high level language (first description) which is considered to become the overhead for the second computer, it becomes possible to burden the first computer with its processing. In short, the processing of the high function portion of the high level language (first description) which is considered to become the overhead for the second computer can be implemented without using any resources of the second computer.

Before executing the first code, the first computer takes in information from the second computer. For example, the first computer executes the monitor command sequence, and acquires the internal state (for example, such as the state of the stack area) and so on of the second computer obtained at the time when the second code has been executed. By referring to the information of the stack area and so on, and by executing the first code, the high function portion (first description) of the high level language which is considered to become the overhead for the second computer is simulated.

The second code is a code representing an interrupt instruction such as TRAP. By executing the interrupt code, the second computer branches to processing using the interrupt handler. The interrupt handler prescribes, for example, processing of supplying address information of the second code (for example, such as an instruction address of the interrupt instruction) to the first computer. The interrupt handler can be embedded in, for example, a part of an OS (operating system) of the second computer, or can be liked to the second code as a debug monitor program.

Association data for associating address information of the second code with the first code are previously generated so that the first computer may refer thereto. Therefore, in response to the execution of the second code conducted by the second computer, the first computer can simply select the first code to be executed from among the plurality of first codes.

The conversion to the first code, the conversion to the second code, and the conversion to the third code can be conducted using the compiler. The debugging of the source program can be conducted using the debugger.

If the target apparatus is defined as a single development subject when attention is paid to a system to be developed, then the first computer is a computer forming the debugger system and the second computer becomes a computer which forms the target apparatus. In the real system, the source program can be executed by the target apparatus alone. In other words, if the high function corresponding portion of the high level language is a language function such as exception processing desired to be used exclusively only during the program debugging and it is not necessary to execute the high function corresponding portion of the high level language in the real system, then the target apparatus can be activated with being disconnected from the host apparatus as a stand-alone system by replacing the second code such as the TRAP instruction in the final object program with, for example, a NOP instruction.

On the other hand, when it is supposed to reduce the load of the target apparatus such as a client on the network in the real system, for example, it becomes possible to leave the second code such as the TRAP instruction in the final program, to embed the first code and the access command sequence in the host apparatus, and to make the host apparatus of the network execute the overhead portion which is the high function portion of the high level language, even after the operation of the final system. In such a case, the first computer is supposed to be a computer which forms the host apparatus of the network, and the second computer is supposed to be a computer which forms an information terminal apparatus serving as the target apparatus.

(3) Storage medium of program

From the viewpoint of storage media for storing a program utilized to implement the system developing method, the present invention will now be described.

Storage media (31, 32) record a program so as to be capable of being read by a computer. The recorded program includes an input step (S1) for inputting the source program containing the first description and the second description, a first conversion step (S6) for converting the inputted first description to the first code which can be executed by the first computer, a second conversion step (S4) for converting the inputted first description to the second code which represents a function different from a function represented by the first description, and which can be executed by the second computer, and a third conversion step (S3) for converting the inputted second description to the third code which can be executed by the second computer. If a computer is made to read the contents of the storage media to form a compiler system and a debugger system, then the above described system developing method can be easily implemented.

This program may be stored in one storage medium, or may be distributed among a plurality of storage media. Alternatively, the program may be recorded on the storage medium together with different data and programs.

Means for taking in this program in a storage medium is not restricted at all. The program may be taken in by plastic molding as in CD-ROMs, by a magnetic change as in a hard disk and a floppy disk, or via a transmission line.

If the second code which can be executed by the second computer is an interrupt code representing an interrupt, then the program may further include the step of prescribing an interrupt handler linked to the interrupt code. In the case where the operating system of the second computer supports the interrupt handler, it is not necessary to prescribe the contents of the linked interrupt handler one by one.

The program may further include the step of forming a table indicating the association of the address of the interrupt code in the second computer with the first code which can be executed by the first computer.

The computer which reads and executes the program is the computer forming the compiler system and the debugger system. At this time, the first computer is a computer forming the debugger system, and the second computer is a computer forming the target apparatus. When previously supposing the utilization of the network of the system to be developed, the first computer is a computer forming the host apparatus, and the second computer is a computer forming the information terminal apparatus.

(4) Host apparatus

From the viewpoint of the information processing apparatus such as the host apparatus, which executes or simulates the high function corresponding portion for the target developed by the above described system developing method and so on, the present invention will now be described.

The information processing apparatus (40) receives from the information terminal apparatus (41), which has a central processing unit (50), the address information of the predetermined instruction code (for example, such as an instruction code representing an interrupt instruction) in the program executed in the information terminal apparatus (41), takes in the internal information of the information terminal apparatus (41) on the basis of the received address information, and executes the processing prescribed in correspondence to the received address information, using the taken-in internal information. This information processing apparatus (41) is optimum to the host apparatus in the real system using the target apparatus having the second computer developed using the above described system developing method. The information processing apparatus (41) can execute as proxy the overhead function in the information terminal apparatus handled as the target apparatus.

If the information terminal apparatus finds the address of the internal information to be taken in on the basis of the received address information in order to take in the internal information, then it can be avoided to burden the information terminal apparatus with a load.

(5) Information terminal apparatus

From the viewpoint of the target developed by the above described system developing method and so on, the present invention will now be described.

The information terminal apparatus (41) such as a target stores a program including a specific instruction code such as an instruction code representing an interrupt instruction, and transmits the address of the instruction code to outside by executing the specific instruction code in the central processing apparatus (50). The information terminal apparatus (41) such as a target inputs an external request supplied from outside in response to the external transmission of the address, and supplies the predetermined internal information to outside in response to the inputted external request. By only executing an instruction such as an interrupt instruction, it is possible to notify the host apparatus in which instruction execution state on the program memory space the information terminal apparatus is. By conducting the processing corresponding to the address, the host apparatus can execute the processing having an overhead which is large to the information terminal apparatus, instead of the information terminal apparatus.

(6) Information processing system

From the viewpoint of the information processing system providing the client or the information terminal apparatus with service via the transmission line, the present invention will now be described.

Supposing an information processing system having such a server receiving a request of service via a transmission line or a network as the aggregate of transmission lines to provide the service, the server receives an instruction address of a client to thereby provide service corresponding to the instruction address, instead of calling a program of the server from the client. In other words, in the information processing system having the host apparatus (40) which can be connected to the transmission line, the host apparatus includes an execution unit (53P, 53M) which can execute a function corresponding to address information. The host apparatus receives the address information in the memory space of the program outputted from an information terminal apparatus (41, 42, 43) storing the program, and provides the information terminal apparatus with a function corresponding to the received address information. In this way, there is adopted a protocol in which a host apparatus (server) receives an instruction address of an information terminal apparatus (client) to thereby provide the information terminal apparatus with service according to the instruction address. Therefore, the communication processing between the host apparatus and the information terminal apparatus is simple. Furthermore, it is possible to form a program for prescribing the processing of outputting the address information in the information terminal apparatus and a program for conducting the processing corresponding to the address information in the host apparatus, by applying the above described system developing method. Therefore, the cost reduction of the data processing system for providing the client or the information terminal apparatus with service via the network or the like can also be implemented.

The execution unit is adapted to be able to provide functions respectively corresponding to a plurality of address information pieces. The execution unit may also form the access information for accessing the information terminal apparatus on the basis of the received address information.

In the program, a code representing an interrupt instruction is provided. The address information may be transmitted by executing the code which represents the interrupt instruction.

(7) Information processing system

Such an information processing system providing a program via a transmission line is supposed. In other words, there is supposed such a system downloading a program via the Internet or the like, or such a system in which the server provides software parts to be used in a program generated in a client. At this time, it is difficult or uneconomical in some cases to execute itself all programs, from the viewpoint of the resources of the client. Paying attention to this, a program desired by the client is divided into at least two programs. The server provides the client with one of the programs, and executes the other of the programs in response to a request from the client. For example, in an information processing system having the host apparatus (40) which can be connected to a communication network, the host apparatus provides the information terminal apparatuses (41, 42, 43) with the first program among the first program (PGM1) and the second program (PGM2) which should be used as one body, and executes the second program in response to a request from these terminal apparatuses.

The first program may be transmitted from the information processing system to the information terminal apparatus. The first program and the second program may be formed from a common source program. In this case, the above described system developing method can be applied. The above described request may include the address information in the first program.

(8) Information processing system

Returning to the viewpoint of solving the overhead of the processing conducted by the client, in the information processing system having the host apparatus (40) which can be connected to the information terminal apparatus, the host apparatus provides the information terminal apparatuses (41, 42, 43) with a program that requests the processing to the host apparatus, and executes the processing in response to requests from these information terminal apparatuses. The program is provided toward the transmission line (44), and the above described requests are supplied from the transmission line. For the purpose of the system cost reduction, the program to be provided to the information terminal apparatus and the program corresponding to the processing should be formed from a common source program.

(9) Information processing method

From the viewpoint of an information processing method for providing the client or the information terminal apparatus with service via the network or the like, the present invention will now be described.

Supposing that a service request is received via the network in the same way as the viewpoint of the above described information processing system, the server receives an instruction address of the client to thereby provide the client with service corresponding to the instruction address, instead of calling a program of the server from the client. In other words, in an information processing method in which the server provides the client with service via the network, the server receives address information in the address space of the program outputted from the information terminal apparatus storing the program, via the network, executes the processing for responding to a request of service corresponding to the received address information in the execution unit, and transmits service based on the result of the execution to the client via the network. In this way, there is adopted a protocol in which a server receives an instruction address of a client to thereby provide the client with service according to the instruction address. Therefore, the communication processing between the server and the client is simple. Furthermore, the cost reduction of the data processing system for providing the client or the information terminal apparatus with service via the network or the like can also be implemented.

Furthermore, there is supposed such an information processing method providing a program via the network (for example, such a method that the server provides program downloading via the Internet or the like, or the server provides software parts to be used in a program generated in the client). At this time, it is difficult or uneconomical in some cases to execute itself all programs, from the viewpoint of the resources of the client. Therefore, in an information processing method in which the server provides the client with service via the network, the server transmits the first program among the first program and the second program which should be used as one body, to the client via the network. In response to a request from the client, the server executes the second program.

### BRIEF DESCRIPTION OF THE DRAWINGS

FIG. 1 is a diagram exemplifying relations among various kinds of software utilized in a system developing method according to the present invention;

FIG. 2 is a system configuration diagram exemplifying a data processing system used for target machine development;

FIG. 3 is a diagram exemplifying details of a compile function concerning a first description conducted by a compiler;

FIG. 4 is a diagram schematically showing a language function of C++;

FIGS. 5A and 5B are diagrams showing areas of a frame pointer and a deallocation function address that a stack frame typically has in order to implement deallocation of an object in the C++ language;

FIG. 6 is a diagram of a stack frame excluding areas of a frame pointer and a deallocation function address;

FIG. 7 is a flow chart exemplifying a system developing method used when developing a client system;

FIG. 8 is a diagram exemplifying a program generated using the method of FIG. 7;

FIG. 9 is a system configuration diagram exemplifying a system development apparatus used when developing a client system;

FIG. 10 is a block diagram exemplifying such an information processing system that a server provides a client with service via a network;

FIG. 11 is a block diagram showing a concrete example of a client;

FIG. 12 is a block diagram showing a concrete example of a server;

FIG. 13 is a flow chart exemplifying an execution control state of an object program for client conducted by a client;

FIG. 14 is a flow chart exemplifying an execution control state of an object program for server and a command sequence for client access conducted by a server;

FIG. 15 is a block diagram schematically showing a function of a server when there is supposed such an information processing system providing a program via a network in the information processing system of FIG. 10; and

FIG. 16 is a flow chart showing an example of a data processing method for providing service using address information of a program on a network.

### DETAILED DESCRIPTION OF THE EMBODIMENTS

System Developing Method

A concrete example of a system developing method according to the present invention will now be described. Here, there will now be described the case where a target machine using a microcomputer for embedded control is developed using the C++ high level language as a development language.

FIG. 2 exemplifies a data processing system used for development of a target machine. A host machine 1 is a computer such as a personal computer or an engineering work station. A target machine 3 is connected to the host machine 1 via a transmission line or a network 2. In the host machine 1, its function is implemented by a program and data embedded therein. In the development stage of the target machine, the host machine 1 forms the development environment of a compiler system, a debugger system, and so on. Although it is not necessary to especially describe, a processor, a RAM, a ROM, an interface controller, and so on are mounted on the host machine 1. A display, a keyboard, and auxiliary storage apparatuses such as a hard disk are connected to the interface controller. Data processing can be conducted according to an operation program of the processor.

In developing the target machine 3, a program executed by the microcomputer mounted on the target machine 3 is first described as a source program 4 using the full set of C++ high level language.

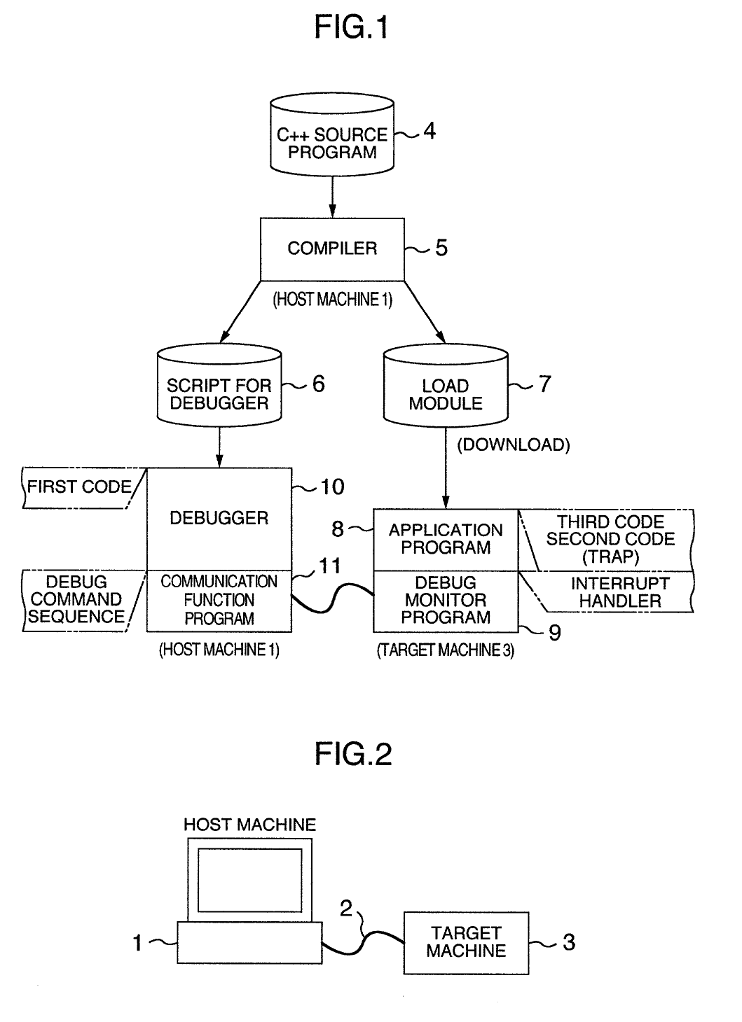

FIG. 1 shows relations among various kinds of software utilized in the system developing method. A compiler 5 converts the source program 4 to a script for debugger 6 and a load module 7. The load module 7 is downloaded to the target machine 3 as an application program 8 and a debugger monitor program 9 of the target machine 3. The script for debugger 6 is executed on the host machine 1 as a debugger 10 and a communication function program 11.

The compiler 5 has the function of compiling the source program 4 described with the full set of C++ language to an object program for the microcomputer of the target machine 3. Here, regarding a description (the second description) of a range (for example, such as a range of “free standing specifications” in the C language specifications of ISO (ISO standards “program language C”)) which can be implemented without an overhead in a microcomputer limited in resources (such as memories and input-output functions), it is converted to an object code (the third code or another code) on the microcomputer. Regarding a description prescribing other processing in the source program 4 (the first description, i.e., a high function description of the high level language such as exception processing), it is converted to an instruction or a command sequence (the first code) which can be executed in the host machine 1, and is converted to, for example, a code (the second code) of a predetermined TRAP instruction as an object code which can be executed on the target machine 3 side. The first code is a code which implements the function defined by the first description on the host machine 1. On the other hand, the second code need only be a code which implements the function different from the function defined by the first description, on the target machine 3. In short, as the second code, a code which can be executed without burdening a load on the target machine 3 can be selected. Thus, paying attention to the function unit of the high level language, the compiler 5 makes the language function unit burdened the load on the target machine 3 executable in the host machine 1. Paying attention to the function unit of the high level language, the compiler 5 reduces the load of the target machine 3.

It is supposed that the host machine 1 is made to execute the first code by the execution of the second code in the target machine 3. For that purpose, the communication between the debugger 10 and the target machine 3 becomes necessary. The necessity is satisfied by the following minimum functions (a), (b) and (c).

(a) a processing request from the target machine 3 to the debugger 10;

(b) reading into and writing from a memory of the target machine 3 conducted by the debugger 10; and

(c) reading into and writing from a register of the target machine 3 conducted by the debugger 10.

These functions are functions which can be implemented by a debug monitor program for the microcomputer of the target machine 3.

On the target machine 3 side, those functions (a), (b) and (c) are supported via the processing of the interrupt handler which is activated by issuing the TRAP instruction in the application program 8 of the microcomputer (target microcomputer) on the target machine 3. Here, what are needed as the functions of the debugger 10 side are the implementation of the high level language function prescribed by the first code corresponding to the instruction address of each TRAP instruction, the acquisition of the information of the instruction address in which the TRAP instruction is placed, and the acquisition of the association information between a variable and its address on the memory of the target machine 3 (such as information indicating a stack state at that time point), which is required to simulate the high level language function on the debugger 10 side. At this point, the interrupt handler has the function of outputting the instruction address of the TRAP instruction code on the target machine 3. In addition, the compiler 5 generates a debug command sequence which makes the contents of the memory and register of the target machine 3 operable on the debugger 10 side using the communication functions of (b) and (c) described above. The debug command sequence and the first code form an association list or an association table in which they can be linked using the instruction address of the corresponding TRAP instruction as a key.

By the way, the TRAP instruction code is a code representing the interrupt instruction, and it is the instruction which causes branching to the processing to be conducted by the interrupt handler indicated by a prescribed vector or the like on the architecture of the microcomputer in the target machine 3. The interrupt handler may be supported by an OS (operating system) of the target machine 3. Alternatively, the compiler 5 may link the prescribed interrupt handler corresponding to that TRAP instruction code to that TRAP instruction code. Although the interrupt handler is illustrated as a part of the debug monitor program 9 in FIG. 1, this is not restrictive.

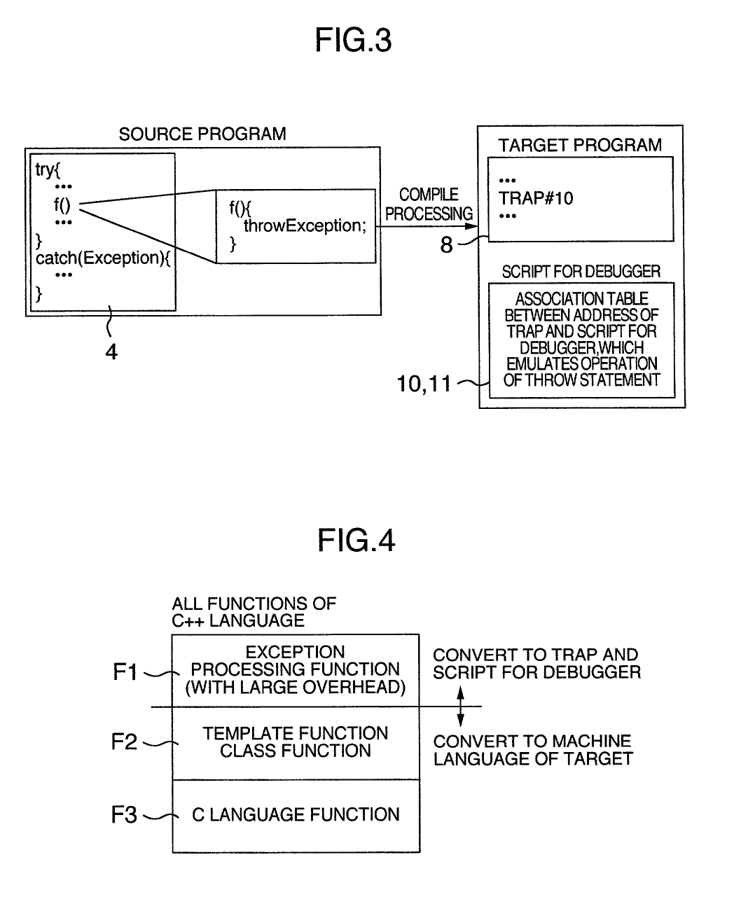

FIG. 3 exemplifies details of a compile function concerning the first description conducted by the compiler 5. If the high function description portion included in the source program 4 is extracted, then the first description is converted to the scripts for debugger 10 and 11 required to simulate the function indicated by the first description in the host system, and is converted to the TRAP instruction code (the second code) for the target program serving as the application program 8. The scripts for debugger 10 and 11 include the first code and the debug command sequence, and form the association table with the instruction address of the corresponding TRAP instruction code.

When debugging a program subjected to compile the processing by the compiler 5, the host machine 1 is operated by the debugger 10 and the target machine 3 is operated by the application program 8. In debugging, the program of the target machine 3 is activated using the debugger 10.

The target machine 3 executes the TRAP instruction corresponding to the high level language function. If the instruction address at the time of issuance of the TRAP instruction is given to the debugger 10, then the debugger 10 searches the debug command sequence and the first code to be executed, on the basis of a PC (program counter register, i.e., address of the TRAP instruction itself) at the time of the issuance of the TRAP instruction, using the above described association table, and executes the debug command sequence and the first code. As a result, the debugger 10 can acquire the information of the stack area in the target machine 3 at that time using the instruction address of the TRAP instruction, and can simulate the high level language function indicated by the first code on the debugger 10 side. Instead of the target machine 3, the debugger 10 simulates the exception processing function, so that it becomes possible to develop the target machine 3 having the limited system resources, using the development environment of the full set specifications of C++.

If the debugging finishes and consequently the high functions such as the exception processing function becomes unnecessary on the target machine 3, then the final software can be constructed by simply switching the debugger monitor program (in other words, the interrupt handler of the TRAP instruction) to software which disregards the TRAP instruction. Alternatively, since the instruction address where the TRAP instruction is embedded is known, the TRAP instruction may also be replaced by a NOP (non-operation) instruction to form the final application program 8. As understood therefrom as well, it is desirable that the debugger 10 has such a function which can indicate whether or not such a TRAP instruction has occurred.

If the target machine 3 is to be implemented on the transmission line or the network, then the final program of the target machine 3 should include the TRAP instruction and the debug monitor program (interrupt handler), and the first code and the debug command sequence which prescribe the overhead portion of the high level language function should be left on the host machine 1 even after the operation of the finally developed system. When the above described predetermined TRAP instruction has been executed in this case by the target machine 3, the high level language function should be simulated using the host machine 1 in the same way as in the debugging.

On the target machine 3, the function of the high level language having the large overhead can thus be implemented with one instruction of the TRAP instruction. Therefore, the overhead of the target machine 3 can be minimized. On the microcomputer or the target machine 3 which is scarce in the resources, the program developed using the high level language can be executed efficiently.

By burdening the overhead function portion of the target machine 3 on the host machine 1, the price of the target machine 3 can be lowered. This is remarkable especially in a system in which a large number of target machines correspond to one host machine as in a telephone office and portable telephones. Even if the target machine 3 is scarce in the resources, the high level language can be mounted with the full specification. This is effective especially in a single chip microcomputer of embedded use, its compiler or debugger, and a communication network.

Simulation of Object Deallocation Processing

A concrete example for simulating on the host machine 1 the aforementioned exception processing for the target machine 3 described with C++ will now be described.

FIG. 4 schematically shows the language function of C++. Although not especially restricted, in FIG. 4, all functions of the C++ language are sorted into an exception processing function (F1) having the large overhead, a template class function (F2), and a C language function (F3). It is now assumed that the exception processing function (F1) is a subject of the conversion to the TRAP instruction and the script for debugger. Other functions are handled as a subject of the conversion to the object code of the target machine 3.

The exception processing function will now be described. In the exception processing in the C++ language, a range of the exception processing which becomes effective and operation at the time of the exception processing are declared by a “catch” syntax. The exceptional conditions are generated by the execution of a “throw” statement. The “catch” syntax and the “throw” statement are not necessarily within the same function. A simplified example of a description using the “catch” syntax and the “throw” statement is indicated as the description of the source program 4 of FIG. 3.

A problem of the exception processing in the C++ language is that not only extra processing which becomes an overhead to a function in which the exception processing is registered and a function which generates the exception is generated, but also the possibility of the exception generation must be provided for in all functions which can be (dynamically) called during that time.

In order to further making this point clear, the processing conducted when the exception has occurred in the C++ language will now be described. If the exception occurs,

(a) the control is shifted to a program point of declaration of the exception processing of the “catch” syntax;

(b) a stack area assigned to from a certain function of the “catch” syntax to a certain function of the “throw” statement by the function calling is deallocated; and

(c) processing declared by the “catch” syntax is executed.

Here, the C++ language is an object oriented language. Therefore, when deallocating the stack area assigned by the function calling, it is necessary to conduct the deallocation processing of the object generated by this function.

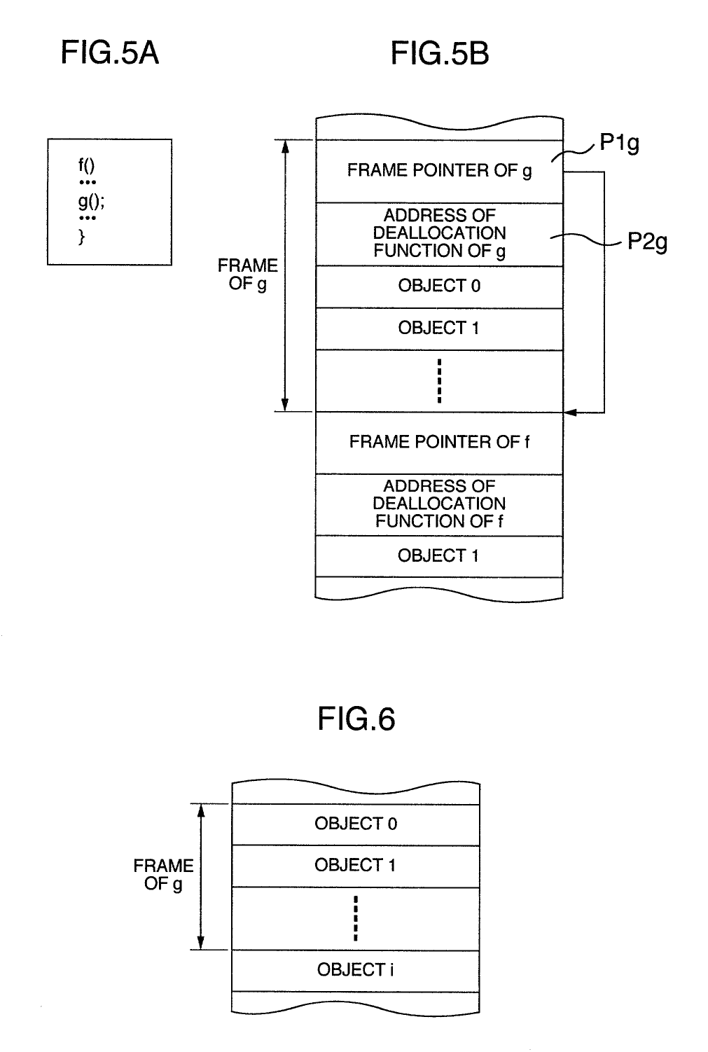

A scheme ordinarily conducted to implement the object deallocation processing in the C++ language will now be described by referring to FIGS. 5A and 5B. An example of the stack frames assigned to the functions f and g shown in FIG. 5A is shown in FIG. 5B. A low order address in the stack frame shown in FIGS. 5A and 5B is the lower part of paper. In the higher side address of the stack frame of the parent function f, the stack frame of the child function g is formed.

(I) In the lowest order address of the stack frame of each function, an area of two words is secured. In the first word, the top address (frame pointer) of the frame of the parent function is held. In the second word, the address of the function for releasing the object of the pertinent function (address of deallocation function) is held. For example, in the stack frame of the child function g shown in FIG. 5B, a frame pointer P1g of the child function g is disposed in the first word, and an address P2g of a deallocation function of the child function g is disposed in the second word.

(II) When the exception has occurred, the object deallocation processing of the pertinent function is conducted. Then, until the stack frame arrives at the function in which the exception processing has been registered, the stack deallocation processing of (III) is conducted.

(III) By calling the address of the deallocation function, the child function g conducts the deallocation processing of the objects (object 0, object 1, . . . ) in its own frame. In addition, the child function g finds the lowest order address of the stack area of the parent function f on the basis of the frame pointer P1g to release all stack frames of the child function g.

However, if the target machine itself does not execute the exception processing, it is possible to omit the areas of the frame pointer occupying two high-order words of the stack frame and the addresses of the deallocation function (for example, P1g and P2g), as exemplified in FIG. 6. As a result, the precious areas of the on-chip RAM can be saved. Namely, the resources of the target machine or the microcomputer mounted on the target machine can be saved. In other words, in the case where there is a limit in machine resources, the above described areas of the frame pointers and the addresses of the deallocation function can be omitted by preventing the target machine 3 itself from executing the exception processing, as described earlier with reference to the system developing method.

However, those two words are necessary not only in the exception processing registering function and the exception processing generating function but also in all functions which can be (dynamically) called between the registration and the exception. Therefore, in the C++ language, an extra area of two words becomes necessary within the stack frame in all functions as compared with the C language. Even if a different implementation method is adopted, there is no change in that the language function of the exception processing of C++ exerts influence upon all functions and demands a machine language which requires more resources as compared with the C language.

For executing the above described operations of (I) to (III) without the areas (for example, such as P1g and P2g) of the frame pointer and the address of the deallocation function in the RAM on the target machine 3, the debugger executes the following processing.

(IV) From the instruction address of the TRAP instruction in the target machine 3 (the program counter at the time when the exception has occurred), a function name including the TRAP instruction and the value of the program counter in the function are found.

(V) From the debug information of this function, a difference in value between a stack pointer at an exit of the function (immediately before the object deallocation) and the current stack pointer is found (this difference is information managed by the compiler 5 and can be included in the debug information.). The stack pointer is changed to the value at the exit of the function.

(VI) From the debug information of this function, the address of the object deallocation function of this function is found, and the function is called. Calling can be conducted by providing a break point at the exit of the deallocation function, setting the value of the program counter at the entry of the deallocation function, and conducting re-execution.

(VII) From the debug information of this function, the size of the stack frame at the exit of the function is found. The stack is deallocated up to the position where the parent function has called this function.

(VIII) The above described (IV) to (VII) are repeated until the position of the stack pointer of the function which has registered the exception processing is reached.

(IX) Since there is a possibility that the exception occurs in the deallocation, it is necessary for the debugger 10 to manage the nest of the above described processing.

The above described processing of (IV) to (IX) is included in the first code described with reference to FIG. 1. All of the processing is conducted on the basis of the debug information which the debugger 10 has. In the target machine 3, it is not necessary to place information required for the processing on the stack frame of the function. In short, even in the case where the debugger 10 conducts the exception processing of the target machine 3 instead, it becomes entirely unnecessary to provide the two-word area which stores the frame pointer and the address of the deallocation function in the stack frame. As a matter of fact, the stack frame size used in (V) and (VII) and the offset value of the stack pointer for the program counter value in the function serve the role of the frame pointer shown in FIG. 5B. Furthermore, the address (in the debug information) of the object deallocation processing of this function used in (VI) serves the role of the address of the object deallocation processing in the stack frame shown in FIG. 5B. Therefore, it is not necessary at all to hold these two words in the stack frame on the RAM of the target machine 3. (System developing method)

There will now be described a system developing method based on the viewpoint of an information processing system in which a server provides a client with service via a transmission line or network.

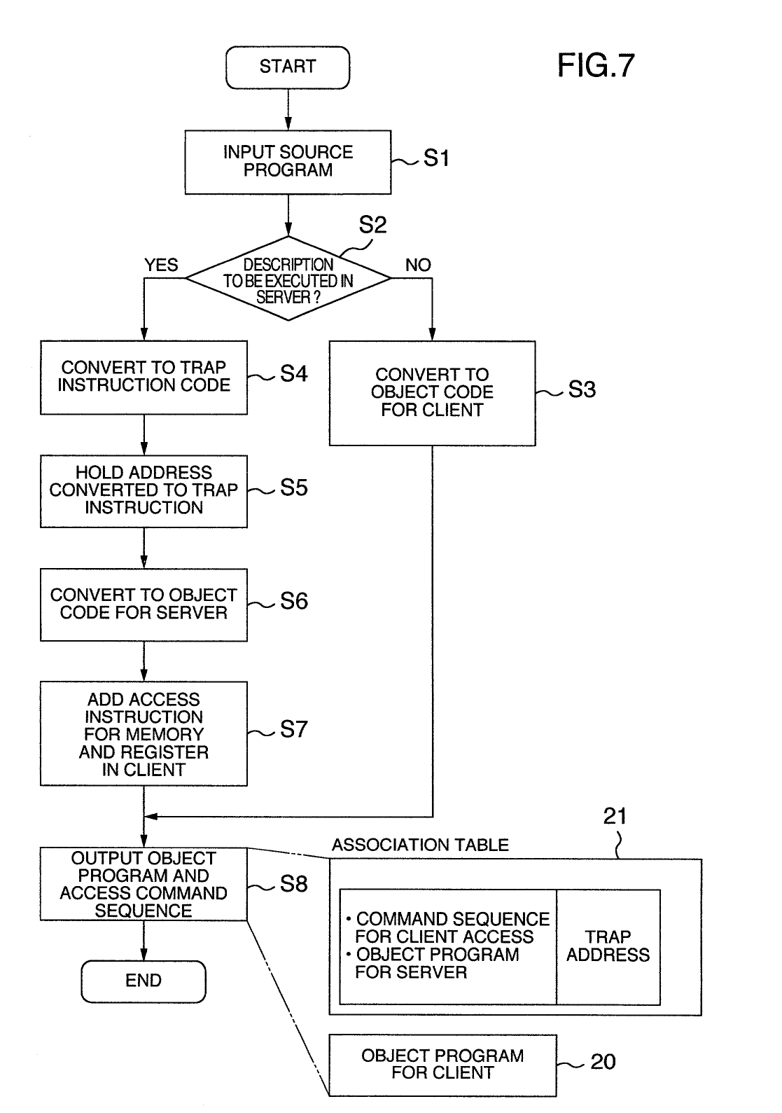

FIG. 7 exemplifies a system developing method used when developing a client system. The source program 4 of the client is described with the full set of C++ language. As a system developing apparatus, there is used a computer such as a personal computer or an engineering work station which incorporates the compiler 5 and the debugger 10 which supports a microcomputer mounted on the client.

The system developing apparatus inputs a source program (S1). It is determined whether or not a description of the inputted source program is a description executed by the server (S2). For example, a description in the range of “free standing specifications” in the above described C language specifications of ISO (ISO standards “Program language C”) is judged to be a description to be executed by the client (second description). A description prescribing other processing in the source program (i.e., high function description of high level language such as exception processing) is judged to be a description to be executed by the server (first description). Besides the high function description of the high level language, a description concerning processing previously considered to be long in processing time or processing previously supposed to be scarce in utilization frequency is also judged to be the first description, even if it is the description in the range of the “free standing specifications”.

For the second description, it is converted to an object code (third code) for client (S3). For the first description, the description is first converted the TRAP instruction code (second code) for client (S4), the instruction address of the TRAP instruction in the memory space of the client is held (S5), the function indicated by the first description is converted to the object code (first code) for the server, and a command sequence for client access corresponding to a debug command sequence for reading from and writing into a memory and a register in the client is generated (S6). Finally, an object program 20 for client generated at the steps S3 and S4, an object program for server generated at the steps S5 to S7, and a command sequence for client access 21 are outputted (S8). The object program for server and the command sequence for client access 21 form an association table in which they are linked to the instruction address of the TRAP instruction code included in the object program 20 for client.

In the same way as the description of FIG. 1, the system developing apparatus thus makes the processing considered to burden the load on the client executable in the server, and reduces the load of the client by taking the machine resources of the client into consideration.

Especially, in this example, in order to minimize the load of the client, the interrupt handler according to the TRAP instruction is supported by a dedicated OS of the client. In addition, the TRAP instruction is executed by the client, and thereby the address of this TRAP instruction is outputted. Thereafter, the communication control responding to a read and write request issued by the server is supported.

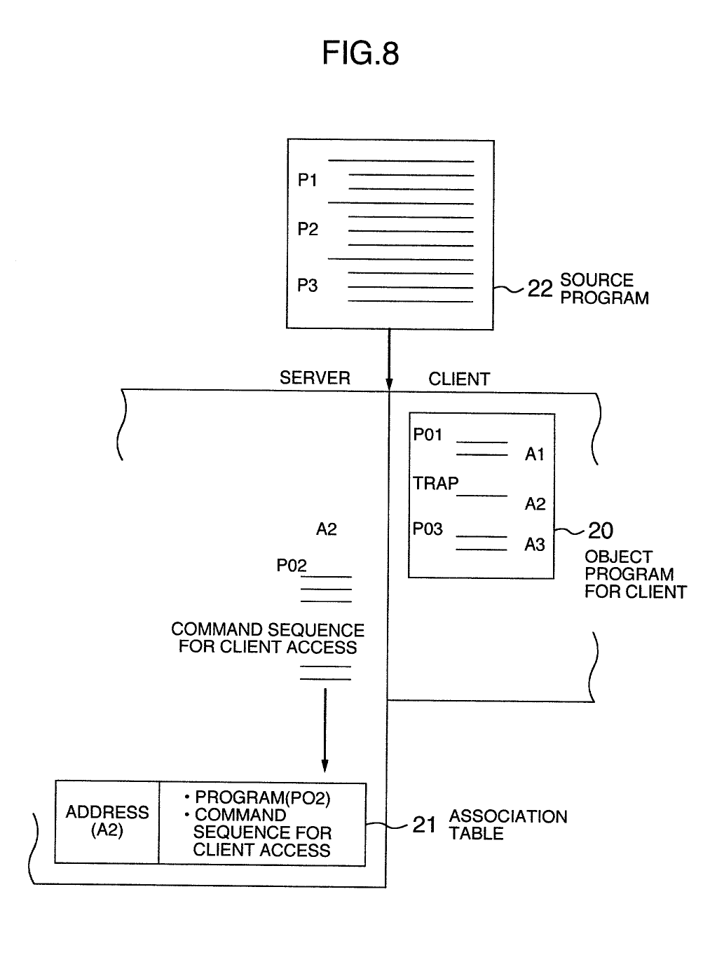

FIG. 8 exemplifies the program generated by the method shown in FIG. 7. In FIG. 8, a source program 22 includes, for example, descriptions of P1, P2 and P3. An object program 20 for client outputted by the method shown in FIG. 7 includes the object codes of PO1 (A1), TRAP (A2), and PO3 (A3). A1, A2 and A3 mean the mapping addresses of the codes. In other words, A1, A2 and A3 represent the addresses where the object codes are disposed in the memory space managed by the microcomputer in the client. The instruction codes PO1 and PO3 are obtained by converting the source descriptions P1 and P3. The object program for server and the command sequence for client access 21 outputted by the method shown in FIG. 7 have such a table structure in which a program PO2 obtained by converting the source description P2 so as to correspond to the object code of the server is linked to a command sequence for client access at the address A2 of the TRAP instruction.

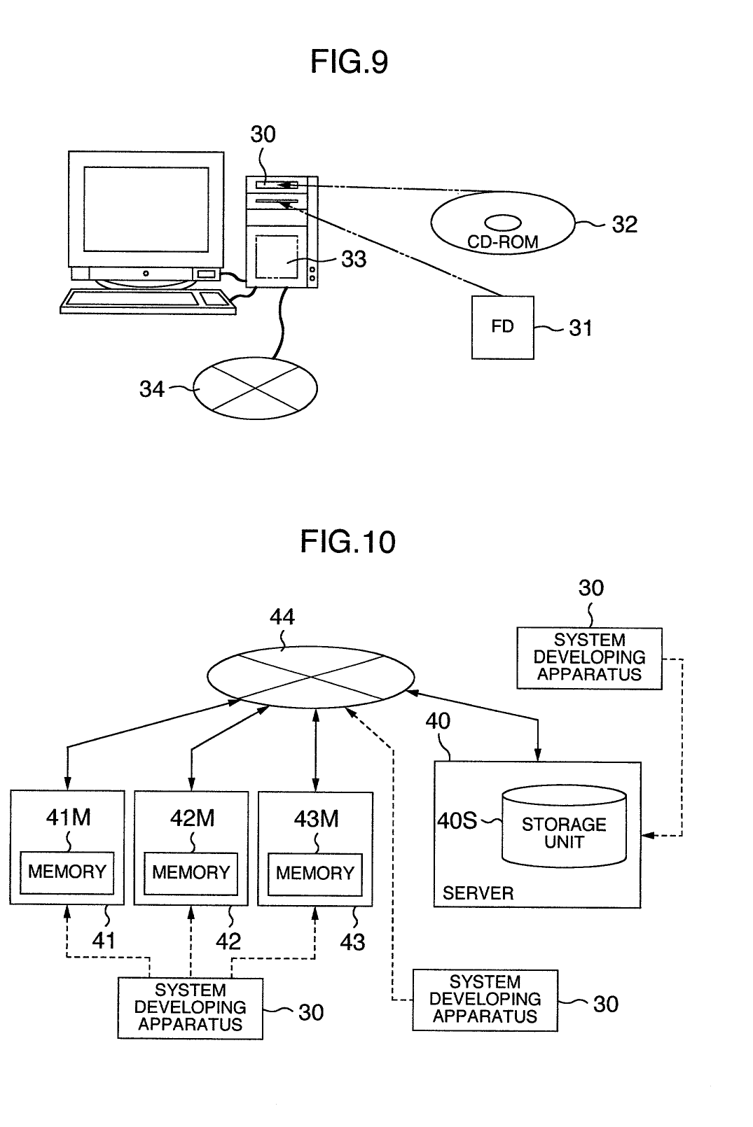

FIG. 9 shows a system developing apparatus 30 used when developing the system of the client. The source program of the client is described with the full set of C++ language. As the system developing apparatus, there is used a computer 30 such as a personal computer or an engineering work station which incorporates a compiler and a debugger which support a microcomputer mounted on the client. A development support program of the compiler, the debugger, and so on is primitively recorded on a storage medium such as one or a plurality of floppy disks (FDs) 31 and CD-ROM disks 32, and then provided. The program recorded on the recording medium is installed and held on a recording medium such as a hard disk apparatus 33 within the computer. Alternatively, such a program is downloaded via a public line network 34 or the like, and is recorded on the hard disk apparatus 33. The development support program makes the computer shown in FIG. 9 execute the steps shown in FIG. 7.

A system development program of the compiler 5 and so on utilized for the system developing method described with reference to FIGS. 1 to 6 is also recorded on a recording medium such as the CD-ROM 32, and provided to the system developing apparatus. In this case, the system developing apparatus is the host machine 1 in FIG. 2, and the host machine 1 reads the system developing program from the storage medium to execute it.

Information Processing System

Such an information processing system in which the server provides the client with service via the transmission line or the network will now be described.

FIG. 10 shows an example of the information processing system. In the information processing system, a server 40 of a network 44 is connected to a plurality of clients 41 to 43. The network 44 may be a public line network, a portable telephone network, a LAN (local area network), the Internet, or a mixture of a plurality of kinds of them. The server 40 has a computer such as a work station or a personal computer, on behalf of which a storage unit 40S is exemplified. The clients 41 to 43 are portable information terminal apparatuses such as portable telephones or PDAs, and have computers such as CPUs, on behalf of which memories 41M to 43M are indicated. The storage unit 40S and the memories 41M to 43M are utilized as data and program storage areas.

As an operation program of the clients 41 to 43, the object program for client 20 obtained using the system developing method shown in FIG. 7 is used. This object program for client 20 is stored in the memories 41M to 43M from the system developing apparatus 30 shown in FIG. 9. Regarding the storage form, storage can be conducted uniformly in a fabrication stage of the clients 41 to 43. Alternatively, in the case where the system developing apparatus 30 is connected to the network 44, the client can individually conduct the download for storage. Storage destinations are the memories 41M to 43M of respective clients 41 to 43. As described earlier, the processing having the large overhead to the client is replaced by the TRAP instruction to be processed by the server 40. Therefore, an association table 21 including the object program for server and the command sequence for client access for that purpose is stored in the storage unit 40S of the server 40 from the system developing apparatus 30. In the same way as the client, this storage form may be either in the fabrication stage or via the network.

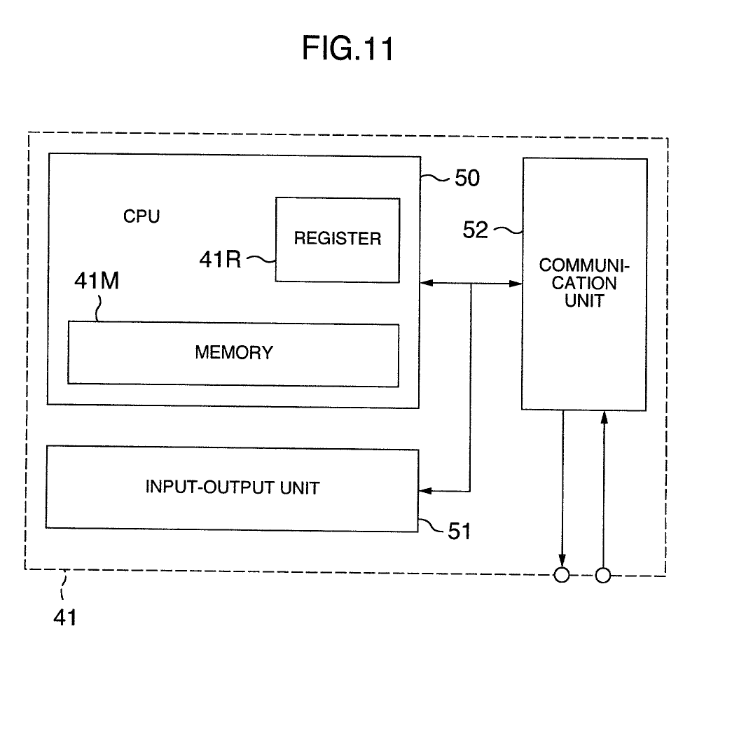

FIG. 11 shows a concrete example of the client 41. The client 41 includes a CPU (central processing unit) 50, an input-output unit 51, and a communication unit 52. The CPU 50 includes an instruction control section for decoding a fetched instruction to generate a control signal, and a computing section controlled based on the control signal. The CPU 50 executes the fetched instruction. In FIG. 11, a register 41R and a memory 41M of the computing section are exemplified representatively. The memory 41M includes, for example, electrically rewritable nonvolatile memory which retains the operation program of the CPU, and a RAM serving as the work area of the CPU. The input-output unit 51 includes a display, a key switch, a speaker, and a microphone. The input-output unit 51 implements the man-machine interface function. The communication unit 52 is means for interfacing the client 41 with outside. For example, in the case of a portable telephone, the communication unit 52 includes a high frequency section, a modulation and demodulation processing section, an A/D conversion section, a D/A conversion section, and so on. The communication unit 52 is made communicable via the portable telephone network. Alternatively, the communication unit 52 may be a LAN adapter, a MODEM adapter, a serial interface, a parallel interface, or the like. Other clients 42 and 43 are also formed in the same way.

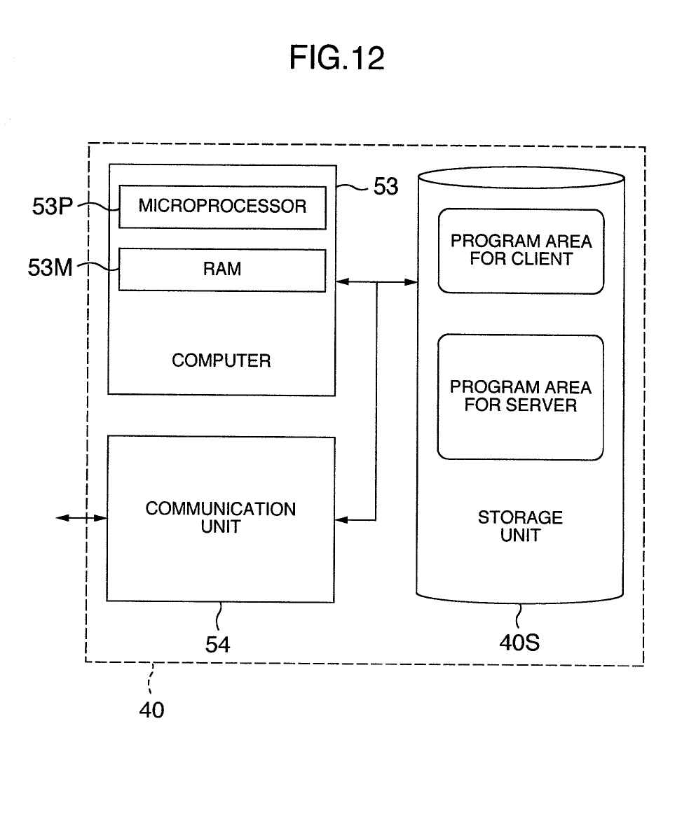

FIG. 12 shows a concrete example of the server 40. The server 40 includes a computer 53 such as a work station, a communication unit 54, and a storage unit 40S. The computer 53 includes, for example, a microprocessor 53P serving as an execution unit, and a RAM 53M utilized as a work area of the microprocessor 53P. Besides, the computer 53 includes a man-machine interface circuit which is not illustrated. The storage unit 40S includes a program area for client as well as a program area for server. The program area for client is an area for storing the association table 21 including the object program for server and the command sequence for client access. An operation program for peculiar operation as the server is stored in the program area for server. The communication unit 54 has communication functions of a router, a modem a LAN, and so on, which can be connected to the network 44.

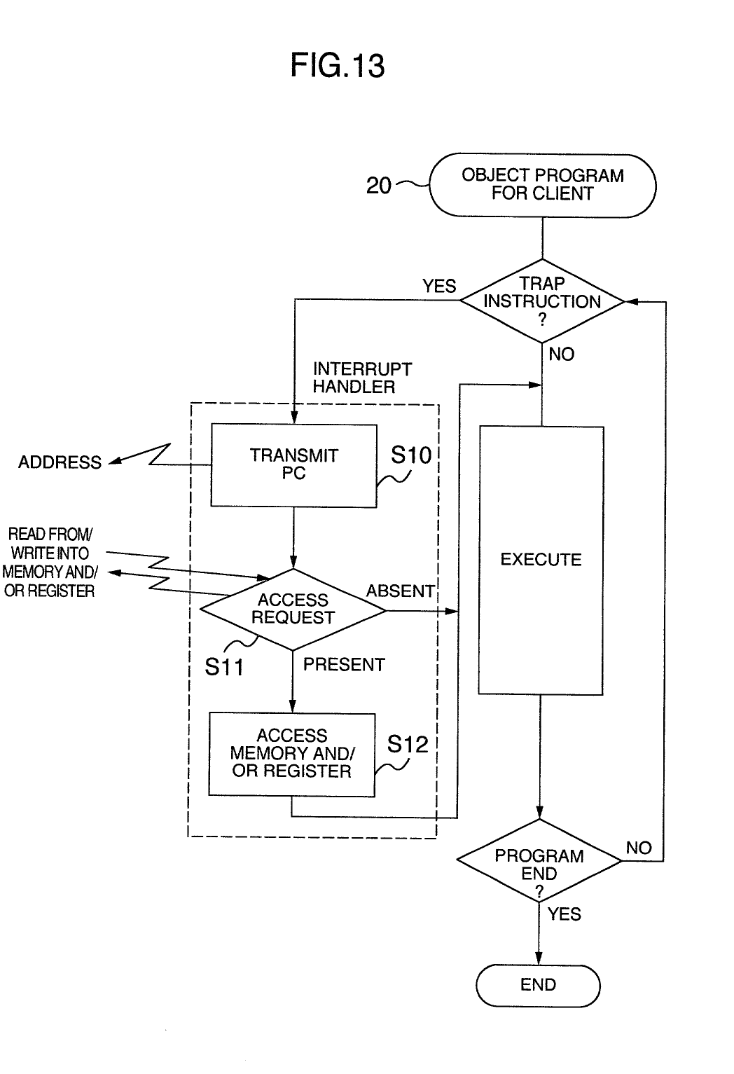

FIG. 13 shows an execution control state of the object program for client 20 conducted by the client 41.

The client 41 retains the object program 20 for client including the TRAP instruction code, in the memory 41M. If the CPU 50 executes the TRAP instruction code included in the object program 20 for client, then a corresponding interrupt handler is activated and the interrupt handler transmits an address of this instruction code (address in the memory space managed by the CPU 50) to outside via the communication unit 52 (S10). If the server 40 issues an output request for a stack area state at that time in response to the transmission of the address to outside, then the request is inputted (S11). In response to the inputted request, the client 41 accesses internal information such as the stack area state, and provides the server 40 with the internal information (S12). By only executing an instruction such as the TRAP instruction, the client 41 can notify to the server 40, in which instruction execution state on the program memory space the client 41 is. Therefore, by conducting the processing corresponding to the address, the server 40 can execute the processing which is large in overhead to the client 41, instead of the client 41.

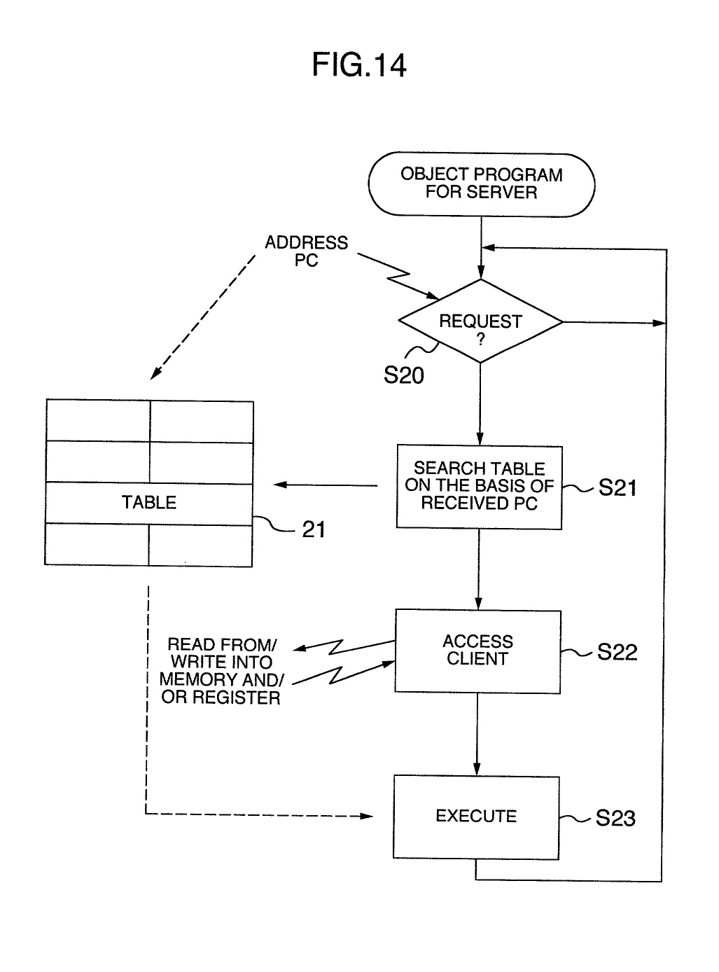

FIG. 14 shows a program and command execution control state conducted by the server 40 using the association table 21.

From the client 41 including the CPU 50, the computer 53 of the server 40 receives the address information (address PC) of a predetermined instruction code (for example, the TRAP instruction code) included in a program executed by the client 41. Thereby, the computer 53 of the server 40 judges that there is a program execution request of the association table 21 (S20). The computer 53 searches the association table 21 using the received address information as a key, and loads an object program for server and a command sequence for client access linked to the address information, from the storage unit 40S into the RAM 53M (S21). The computer 53 executes the command sequence for client access, takes in internal information such as the state of the stack area of the client 41 at that time on the basis of the address information (S22), and executes the object program for server of the association table 21 linked to the address information using the internal information taken in (S23). The server 40 can conduct the overhead function of the client 41 instead of the client 41. In order to take in the internal information, the server 40 conducts the processing for finding the address of the internal information to be taken in on the basis of the received address information, by executing the command sequence for client access of the association table 21. In this point as well, therefore, the client 41 is not burdened.

Information Processing Method

When it is supposed to receive a service request via the network 44 in the information processing system shown in FIG. 10, the client 41, 42 or 43 does not call the program of the server 40, but the server 40 receives an instruction address of the client 41, 42 or 43 to thereby provide service depending on the instruction address. In other words, as such an information processing method in which the server 40 provides the client with service via the network 44, the server 40 receives the address information in the address space of a program outputted from the client 41, 42 or 43 which stores a program (a program to be executed by the client), via the network, executes the processing for responding to a request of service corresponding to the received address information, in the execution unit 53P and 53M, and transmits service based on the result of the execution to the client via the network 44. In this way, there is adopted a protocol in which the server 40 receives the instruction address of the client 41, 42 or 43 to thereby provide the client 41, 42 or 43 with the service according to the instruction address. Therefore, the communication processing between the server 40 and the client 41, 42 or 43 is simple. Furthermore, the program for prescribing the address information output processing in the client 41, 42 or 43 and the program for conducting processing according to the address information in the server 40 can be formed by applying the above described system developing method. Therefore, the cost reduction of the data processing system for providing the client with service via the network 44 can also be implemented.

Although not especially restricted, it is not necessary to discriminate, from which client the server 40 has received the address information, on the basis of the received address information. In other words, the establishment of the one-to-one communication between the client 41, 42 or 43 and the server 40 can be implemented using the function which the system originally has. For example, in the case of the LAN, the client can be discriminated using an IP address assigned to the client. In the case of the portable telephone network, the client can be discriminated using ID information or the like peculiar to the client. In the case where any divertible discrimination means is not provided, the address information with a prefix code peculiar to the client added thereto is given to the server. By doing so, the client which should be provided with the service can be discriminated using the prefix code.

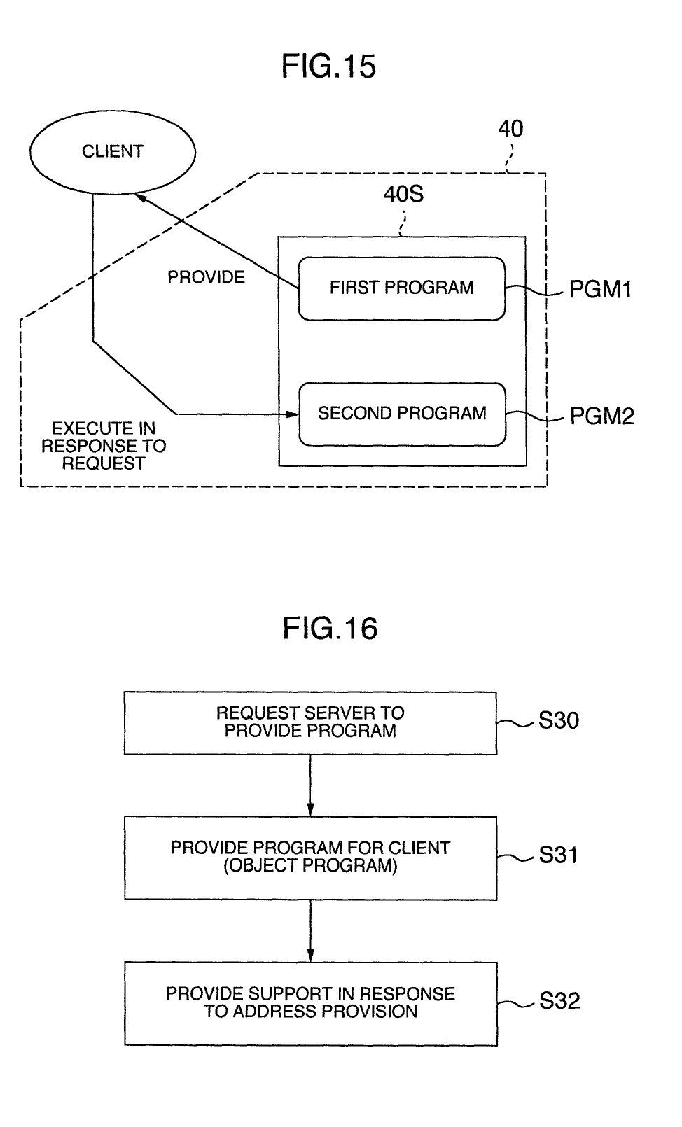

Furthermore, there is supposed an information processing system show in FIG. 10 which provides a program via the network 44. In other words, there is supposed a system downloading a program via the Internet or the like or such a system in which the server provides software parts to be used in a program generated in the client. At this time, it is difficult or uneconomical in some cases to execute itself all programs, from the viewpoint of the system resources of the client. Paying attention to this, a program desired by the client 41, 42 or 43 is divided into at least two programs (for example, such as the first program PGM1 and the second program PGM2) as exemplified in FIG. 15. The server 40 retains the programs resulting from the division in the storage unit 40S. The server 40 provides the client 41, 42 or 43 which has issued a download request, with the first program PGM1, and executes the second program PGM2 in response to a request from the client. This execution is conducted to obtain a result or service needed by the client which has issued the request. Therefore, in the case where it is necessary to return the execution result to the client, the result is immediately returned to the client as the provision of the service. For example, in the case where the second program PGM2 is a fault diagnostic program of the client, service according to the diagnostic result can be provided. In the case of a software fault, rewriting or redownloading of the program can be made possible. In the case of a hardware fault which requires repair, the necessary disposal, the place to be contacted, or the like is announced.

From a nature in which the first program PGM1 and the second program PGM2 are originally utilized as one or one body, it is efficient to form the first program PGM1 and the second program PGM2 from a common source program. In this case, the system developing method described with reference to FIG. 7 and so on may be applied. The first program PGM1 may be a program positioned as the object program for client 20. Furthermore, the second program PGM2 may be a program positioned as the object program for server and the command sequence for client access of the association table 21. Here, the above described request is necessarily conducted using the address information in the first program PGM1 as the main constituent.

Such a processing form can be grasped as one of data processing methods shown in FIG. 16. In other words, if the client 41, 42 or 43 requests the server 40 to provide a program (S30), then the server 40 provides the requesting the client with the program for client via the network 44 (S31). For example, the first program PGM1 included in the first program PGM1 and the second program PGM2 which should be used as one body is transmitted to the requesting client via the network 44. Thereafter, the server 40 provides the client with the support concerning the program, in response to the address supply from the client (S32). This support is, for example, the execution of the second program PGM2. The contents of the support may be not only the execution of the program of the server 40 side but also the version up of the program, the restoration of a destroyed program module, and so on. In that case, it is necessary to know the version of the program retained by the client. By executing the predetermined client access command sequence in the same way as the information acquisition of the stack area, to thereby acquire the version information from the client, and the support according to the version can be conducted.

Heretofore, the invention made by the present inventor has been described concretely on the basis of the embodiments. However, the present invention is not limited thereto. It is a matter of course that various changes can be made without departing from the spirit of the invention.

For example, the present invention has been described by taking C++ as an example of the high level language. However, the present invention can be applied to the case of Fortran 90 or Java in the same way. In short, it is possible to make the server or the host apparatus execute as proxy the function considered to be the overhead function for the client or the target apparatus, using the code such as the TRAP instruction and the address output of the code. Furthermore, the storage medium of the program is not limited to the CD-ROM, the FD and the hard disk, but may also be a medium having a different storage form, such as an MO (Magnet-Optics) disk or a flash memory card. Furthermore, the address outputted by the client is not limited to the address of the code such as the TRAP instruction. For example, instead of the address of the TRAP instruction, an address of an instruction code which was executed several instructions before the TRAP instruction may be used. In short, in order that the server may access information in the client (information used by the server to implement the processing in which the server is requested to execute as proxy) on the basis of an address supplied from the client, the address outputted by the client need only be an address which is capable of specifying the processing in which the server is requested to execute as proxy, and which is managed by the CPU in the client.

Effects obtained by the representative aspects of the present invention will now be described briefly.

The function considered to be the overhead function for the client or the target apparatus as represented by the exception processing function of the C++ language is replaced by the instruction code such as the TRAP instruction. By executing this instruction code, the address of that code is outputted, for example. Thereby, the server or the host apparatus is made to execute as proxy the overhead function. As a result, it is possible to implement the system developing method which makes the full set of high level language function including the high level language function which might be the overhead to the target apparatus, available. In an embedded system susceptible to the restrictions of the system resources, this makes it possible to develop the system using the high level language such as the full set of C++ language. Regarding the embedded system as well, the standardization of the programs using the high level language becomes possible. The transportation of the program developed using the high level language on the work station also becomes possible.

By providing the storage medium which has the program implementing the above described system developing method recorded thereon, the system development using the system developing method can be facilitated.

Supposing an information processing system having such a host apparatus which receives a request of service via a transmission line or a network as the aggregate of transmission lines to provide the service, the host apparatus receives the instruction address of the information terminal apparatus to thereby provide service corresponding to the instruction address, instead of calling the program of the host apparatus from the information terminal apparatus. By adopting such a system configuration, the communication processing between the host apparatus and the information terminal apparatus can be simplified. Furthermore, it is possible to implement the cost reduction of the data processing system which provides the information terminal apparatus with service via the network or the like, and the efficiency improvement of the data processing method.

What is claimed is:

1. A system developing method comprising the steps of:
converting a first description in a source program having a plurality of descriptions, to a first code which can be executed by a first computer;
converting said first description to a second code which represents a function different from a function defined by said first description and which can be executed by a second computer, and converting a second description in said source program to a third code which can be executed by said second computer; and
executing said first code in said first computer in response to execution of said second code conducted by said second computer in debugging of said source program.

2. A system developing method according to claim 1, wherein said first computer takes in information from said second computer before executing said first code.

3. A system developing method according to claim 2, wherein
said second code is a code representing an interrupt instruction; and
address information of said second code is supplied to said first computer by execution of said second code.

4. A system developing method according to claim 1, wherein association data for associating address information of said second code with said first code is generated so that said first computer can refer thereto.

5. A system developing method according to claim 1, wherein conversion to said first code, conversion to said second code, and conversion to said third code are conducted using a compiler.

6. A system developing method according to claim 5, wherein debugging of said source program is conducted using a debugger.

7. A system developing method according to claim 1, wherein
said first computer is a computer forming a debugger system; and
said second computer is a computer forming a target apparatus.

8. A system developing method according to claim 1, wherein
said first computer is a computer forming a host apparatus; and
said second computer is a computer forming a terminal apparatus serving as a target apparatus.

9. A storage medium for storing a program so that a computer can read said program, wherein said program comprises:
an input step of inputting a source program including a first description and a second description;
a first conversion step of converting said inputted first description to a first code which can be executed by a first computer;
a second conversion step of converting said inputted first description to a second code which represents a function different from a function represented by said first description, and which can be executed by a second computer; and
a third conversion step of converting said inputted second description to a third code which can be executed by said second computer.

10. A storage medium according to claim 9, wherein said program is stored in one storage medium.

11. A storage medium according to claim 9, wherein said program is taken in said storage medium via a transmission line.

12. A storage medium according to claim 9, wherein said second code which can be executed by said second computer is an interrupt code representing interrupt.

13. A storage medium according to claim 12, wherein said program further comprises the step of prescribing an interrupt handler linked to said interrupt code.

14. A storage medium according to claim 12, wherein by execution of said interrupt code, said interrupt code branches to processing of an interrupt handler prescribed by an operating system of said second computer.

15. A storage medium according to claim 12, wherein said program further comprises the step of forming a table indicating association of an address of said interrupt code in said second computer with said first code which can be executed by said first computer.

16. A storage medium according to claim 9, wherein
said first computer is a computer forming a debugger system; and
said second computer is a computer forming a target apparatus.

17. A storage medium according to claim 9, wherein
said first computer is a computer forming a host apparatus; and
said second computer is a computer forming an information terminal apparatus.

18. An information processing apparatus, wherein
said information processing apparatus
receives from an information terminal apparatus including a central processing unit, address information of a predetermined instruction code in a program executed in said information terminal apparatus;
takes in internal information of said information terminal apparatus based on said received address information; and
executes processing previously prescribed in association with said received address information, using said taken-in internal information.

19. An information processing apparatus according to claim 18, wherein an address of said internal information to be taken in is found based on said received address information.

20. An information processing apparatus according to claim 19, wherein said predetermined instruction code is a code representing an interrupt instruction.

21. An information terminal apparatus wherein
said information terminal apparatus
stores a program including a specific instruction code; and
transmits to outside an address of said specific instruction code by executing said specific instruction code in a central processing unit.

22. An information terminal apparatus according to claim 21, wherein said specific instruction code is a code representing an interrupt instruction.

23. An information terminal apparatus according to claim 21, wherein
said information terminal apparatus
inputs an external request supplied from outside in response to external transmission of said address; and
provides, responsive to said inputted external request, predetermined internal information to outside.

24. An information processing system having a host apparatus which can be connected to a transmission line, wherein
said host apparatus
comprises an execution unit capable of executing a function corresponding to address information;
receives address information in a memory space of a program outputted from an information terminal apparatus storing said program; and
provides said information terminal apparatus with a function corresponding to said received address information.

25. An information processing system according to claim 24, wherein said execution unit can provide functions which correspond to a plurality of address information, respectively.

26. An information processing system according to claim 25, wherein said execution unit forms access information for said information terminal apparatus based on said received address information.

27. An information processing system according to claim 24, wherein
a code representing an interrupt instruction is provided in said program comprises; and
said address information is transmitted by executing said code representing the interrupt instruction.

28. An information processing system having a host apparatus which can be connected to a transmission line, wherein
said host apparatus
provides a terminal apparatus with a first program among the first program and a second program which are mutually related to each other; and
executes, responsive to a request from said terminal apparatus, said second program.

29. An information processing system according to claim 28, wherein said first program is transmitted from said information processing system to said terminal apparatus.

30. An information processing system according to claim 28, wherein said first program and said second program are formed from a common source program.

31. An information processing system according to claim 28, wherein said request comprises address information in said first program.

32. An information processing system having a host apparatus which can be connected to an information terminal apparatus, wherein
said host apparatus
provides said information terminal apparatus with a program which requests said host apparatus to execute processing; and
executes, responsive to a request from said information terminal apparatus, said processing.

33. An information processing system according to claim 32, wherein said program is provided toward a transmission line.

34. An information processing system according to claim 32, wherein said request is supplied from a transmission line.

35. An information processing system according to claim 34, wherein said program to be provided to said information terminal apparatus and a program corresponding to said processing are formed from a common source program.

36. An information processing method in which a server provides a client with service via a network, wherein
said server
receives via said network address information in an address space of a program which is outputted from an information terminal apparatus storing said program;
executes processing for responding to a request of service corresponding to said received address information, in execution unit; and
transmits service based on a result of execution to said client via said network.

37. An information processing method according to claim 36, wherein said execution unit selects processing, which corresponds to said received address information, from a plurality of processing which correspond to a plurality of address information, respectively, to execute said selected processing.

38. An information processing method according to claim 37, wherein execution of processing conducted by said execution unit comprises generation of access information for accessing information to be read from said client based on said received address information.

39. An information processing method according to claim 36, wherein
a code representing an interrupt instruction is provided in said program; and
said address information is transmitted to said network by executing said code representing the interrupt instruction.

40. An information processing method in which a server provides a client with service via a network, wherein
said server
transmits a first program among the first program and a second program which are mutually related to each other, to said client via said network; and
executes said second program in response to a request from said client.

41. An information processing method according to claim 40, wherein said first program and said second program are formed from a common source program.

42. An information processing method according to claim 40, wherein said request comprises address information in an address space of said first program.
